(19) United States
(12) Patent Application Publication
(10) Pub. No.: US 2007/0273552 A1
(43) Pub. Date: Nov. 29, 2007

(54) Control of traffic flow by sensing traffic states

(75) Inventor: Steven Tischer, Atlanta, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/440,659

(22) Filed: May 24, 2006

(51) Int. Cl. G08G 1/095; G08G 1/00; G08G 1/08

(52) U.S. Cl. 340/910; 701/117; 340/907

(57) ABSTRACT

Traffic is controlled by sensing a current state of traffic and comparing it to a common state of traffic to determine deviations. A control scheme is determined based on the deviations, and control signals representative of the control scheme are generated to optimize the flow of traffic. The current state of traffic for an intersection or other advantageous monitoring location may be considered relative to a common state at the intersection or other location as well as relative to a current state of traffic at nearby locations, adjacent intersections, and locations where sensor equipped vehicles are traveling. Sensing occurs over time so the control scheme may be optimized based on consideration of historical data. Intersections or other locations may employ sensor devices to sense traffic state information, to communicate with other sensor devices of other intersections and/or a central controller, and to implement the control schemes to create a network of sensor devices each attempting to optimize traffic based on local and nearby traffic states.

### TECHNICAL FIELD

The present invention is related to the control of traffic. More particularly, the present invention is related to the control of traffic based on sensing traffic states relative to a common traffic state.

### BACKGROUND

Traffic must be controlled to maintain an efficient and safe system of transportation. Traffic at an intersection is typically controlled either by static signs that require the driver to exercise judgment, manually, such as a traffic officer providing hand signals, or automatically by traffic signaling lights that are controlled by programming. Because most intersections are too busy to rely upon driver judgment and because the costs associated with having an officer at an intersection are high, the far majority of intersections are controlled automatically with traffic signaling lights.

The programming for the traffic signaling lights provides for a common mode of operation. This common mode of operation assumes that traffic will stay within certain parameters over a particular period of time, i.e., will have a common state at a point in time. For example, the programming may assume that during weekdays, traffic in a particular direction is heavy during morning hours, light during mid-day hours, heavy during evening hours, and light during night hours. While such programming may be effective when traffic matches the assumptions made, the programming may be ineffective and problematic if a disturbance causes the traffic to deviate from the common state. The programming cannot be modified as quickly as the disturbances can appear and disappear.

To exacerbate the problem, disturbances in traffic are commonplace. For example, an accident or breakdown may cause a large line of vehicles to develop, where the vehicles are moving more slowly and in larger groups through an intersection than the common state defines. Furthermore, traffic may be diverted to different roadways to increase volume beyond that which the common state defines. Additionally, high priority vehicles such as fire engines, those transporting political figures, and the like may cause traffic to deviate from the common state.

Such disturbances result in the ineffective control of traffic due to the programming of the traffic signaling causing the traffic lights to activate as if traffic remained in the common state.

### SUMMARY

Embodiments address these issues and others by providing for adaptation of the control of traffic signaling lights based on sensing deviations of traffic from a common state. Such adaptation includes altering the control scheme of the traffic signaling as necessary to optimize traffic flow for the current state of traffic. The alteration of the control scheme may involve various factors, including local sensing at a traffic signal as well as sensing of traffic state in nearby locations including adjacent intersections. The alternation may be used to stage the progression of traffic through intersections but may also be used to re-route traffic. Furthermore, the common state may be optimized over time based on the continuous sensing of traffic and changing traffic patterns.

One embodiment is a device for controlling traffic. The device includes at least one sensor that produces at least one sensor signal representative of a current traffic state. The device further includes an analysis module that analyzes the sensor signal to determine the current traffic state, to compare the current traffic state to a common traffic state, and to determine deviations of the current traffic state from the common traffic state. The analysis module determines a control scheme based on the deviations, wherein the control scheme controls activation of traffic signaling lights to optimize traffic flow for the current state, and produces control signals representative of the control scheme.

Another embodiment is a device for controlling traffic. The device is located at an intersection or other advantageous monitoring location and senses a current state of traffic at the current location, sends messages to indicate the current state of traffic being sensed, receives messages to indicate the current state of traffic at other nearby locations, and produces control signals for manipulating traffic signaling lights so as to optimize traffic flow wherein the control signal is based on an analysis of the current traffic state at the current location relative to a common state at the current location and relative to the current state of traffic at nearby locations.

Another embodiment is a computer readable medium containing instructions for controlling traffic by performing various acts. The acts involve sensing a current state of traffic for at least one location. The acts further involve comparing the current state of traffic for one location to a common state of traffic for the one location to find deviations from the common state and to determine a control scheme to optimize traffic flow based on the deviations. The acts further involve producing control signals representative of the control scheme to control the activation of traffic signaling lights at or near the one location to optimize traffic flow.

### DESCRIPTION OF THE DRAWINGS

FIG. 1 shows sensor module that senses and analyzes local traffic states according to an exemplary embodiment.

FIG. 2 shows a sensor device including a controller module joined to the sensor module of FIG. 1 for generating a control scheme and control signals for operating traffic signaling lights according to an exemplary embodiment.

FIG. 3 shows an ad-hoc, decentralized network of sensor devices for operating traffic signaling lights according to an exemplary embodiment.

FIG. 4 shows an ad-hoc network of sensor device including centralized control for operating traffic signaling lights according to an exemplary embodiment.

FIG. 5 shows adjacent intersections having sensor devices for sensing the current traffic state and generating control signals for operating traffic signaling lights to optimize traffic flow according to an exemplary embodiment.

FIG. 6 shows an operational flow of a system for operating traffic signaling at one intersection according to an exemplary embodiment.

### DETAILED DESCRIPTION

Embodiments provide for the adaptive control of traffic signaling lights by sensing the current state of traffic and adjusting the control of the traffic signaling lights as necessary to optimize the flow of traffic, including progressing traffic through intersections as well as re-routing traffic when necessary. When determining the adjustment to the control of the traffic signaling lights, the current state at the intersection of interest is considered relative to a common state at the intersection to determine deviations that may be occurring and that require some form of adaptation. Additionally, the current state of traffic from nearby locations including nearby intersections may also be considered. Furthermore, by sensing traffic patterns over time, the common state itself may be optimized.

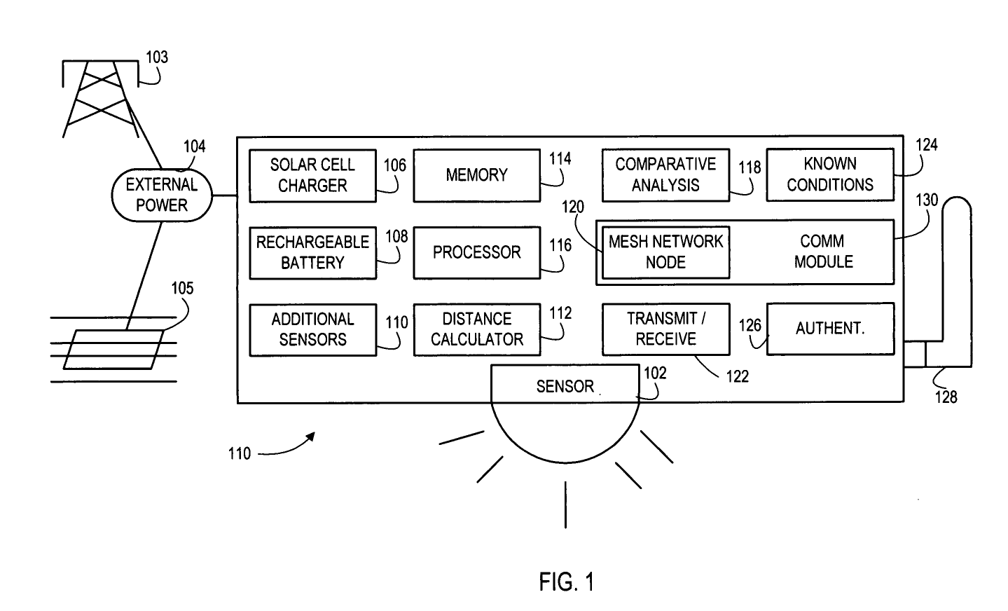

FIG. 1 shows on example of the components of a sensor device 100 that may be employed to sense the current state of traffic according to an exemplary embodiment. The sensor device 100 may be located at an intersection where traffic signaling lights are located so that the sensor device 100 can sense the current state for that intersection which may then be used to control the traffic signaling lights. The sensor device 100 may also be located at other areas that are nearby or otherwise relevant to a particular intersection or set of intersections. For example, sensor devices 100 may be located on poles along side a roadway and in that case, the current state of traffic at that location may become a factor for controlling a traffic signaling light at a nearby intersection of the roadway with another roadway. As another example, sensor devices 100 may be mounted to closed system vehicles, i.e., vehicles that remain within a common system for controlling traffic signals such as city buses and police cars. Furthermore, the sensor devices 100 may be mounted to open system vehicles that pass into and out of the system and establish a mesh network as further discussed below.

The sensor device 100 includes at least one sensor 102, such as a still photo camera or video camera and/or combinational image-speed detector, for capturing images of traffic, either at fixed points in time or over fixed ranges. The sensor device 100 may capture images from various directions including each of the directions that traffic flows in an intersection. This may be accomplished by having a separate camera aimed in each direction, by having cameras that can swivel in 360 degrees, and/or by having cameras situated above all common roads in an intersection so as to have a “bird's eye” view of the objects coming and going. By capturing images from each of the directions of traffic flow, the sensor 102 provides the necessary information for making determinations regarding the number of vehicles currently passing through the intersection in each direction, the number of vehicles currently waiting to pass through the intersection from each direction, and whether any high priority vehicles have approached or passed through the intersection from any of the directions.

The sensor device 100 includes the sensor 102 and various modules for performing operational tasks. To supply power to the sensor 102 and various modules, an external power supply 104 may be provided, such as from the public utility 103. Other sources of external power may include mechanically actuated electrical generators such as a treadle plate 105 placed under the road way to generate power from overhead traffic or a windmill to generate power from the wind of passing traffic. Additionally or alternatively, the sensor device 100 may include a solar cell charger 106 and a rechargeable battery 108 or ultra capacitor whose charge is maintained by the charger 106. Where the external power supply 104 and the battery 108 are included, the battery 108 may provide back-up power in case the external power supply 104 should fail, as in a power outage. In that case, the sensor device 100 may continue to operate to provide the information necessary to adapt the traffic signaling lights.

In addition to the sensor 102, the sensor device 100 may include additional sensors 110 as well. The additional sensors 110 may include temperatures sensors, moisture sensors, wind sensors, sound level sensors, geonavigational positioning sensors, altitude sensors, speed sensors, roadway pressure sensors, Geiger counters, directional sensors, smoke detectors, and the like. The information gathered by these additional sensors 110 may also be factored into the analysis when determining how traffic flow should be optimized including whether to re-route traffic around a particular area.

As one example of using a sound level sensor, if a high noise level is detected for a certain period of time, it may be deduced that a noisy vehicle is stopped for a red light and it may be determined that the red light should turn to green sooner than dictated by the common mode of operation because the noise is causing a disturbance. As another example, if normal sound level is 20 decibels (db) and the sound level recently became 110 db and is staying that high for a significant amount of time such as due to beeping horns, sirens, and so forth, then this may indicate that there is a traffic problem at that location such that traffic destined for that location should be re-routed.

The sensor device 100 also includes memory 114 associated with a processor 116. The processor 116 may be a general-purpose programmable processor or a dedicated purpose processor. The processor 116 in conjunction with the memory 114 implements the various software or firmware modules of the sensor device in order to determine the current state of traffic from the information being collected by the sensor 102 as well as any additional sensors 110 that may be present.

The logical operations performed by the processor 116 and the various associated modules of the sensor device 100 may be implemented as instructions encoded on a computer readable medium. A computer readable medium may be of various forms including magnetic, electronic, and/or optical storage devices as well as transport media such as wired and/or wireless data connections.

One module being implemented by the sensor device 100 is a distance calculator module 112 which calculates the amount of time one or more vehicles will take to reach a next node at a known distance away from the sensor device 100 as one form of analysis that may be performed based on the images and other data being captured. The calculation may be based on stored knowledge regarding the distance to other nearby nodes and the current speed detected for the vehicle traveling in the direction toward a particular nearby node. This amount of time before one or more vehicles are expected to reach a nearby intersection may be communicated either to a central controller or directly to the nearby control device so that this current state information can be considered by a nearby control device when determining how to adapt the control scheme for the traffic signaling lights at the nearby intersection where the nearby control device is located. Control devices and central controllers are discussed in more detail below.

An additional module that may be present is a comparative analysis module 118. This module may employ known conditions maintained by sample module 124, which may be located in memory 114. The known conditions of sample module 124 include the data that represents a standard car, a motorcycle, a bus, a fire engine, a police car, and the like. Accordingly, the analysis module 118 may perform a comparison of the known conditions to each image being captured of the traffic in order to perform pattern recognition, ontologically-based deduction, or other forms of recognition necessary to determine which vehicles and how many are present at any point in time and for any direction so as to output data that defines the current state of traffic. The analysis module 118 may provide accumulator and counter functions based on the vehicles being identified for each of the directions of traffic flow. In certain embodiments, the analysis module 118 may tally the number of known things that have been directly communicated, such as the time a particular city bus has passed through an intersection, and from such tallies over time, patterns may be obtained such that analysis of a current situation may show that there is a deviation, such as a city bus being late, which might indicate the need for steps to be taken. Such steps may include an optimization of the progression or re-routing of traffic and/or alerting authorities of a problem.

A mesh network module 120, which as shown in the exemplary embodiment of FIG. 1 is a sub-module of a communications module 130, may be included. This mesh network module 120 allows for the inclusion of the sensor device 100 within a mesh network to exchange data regarding the current state of traffic across a region. The mesh network may include sensor devices 100 distributed across a particular region, including at intersections within the region and on vehicles traveling within the region, such as closed system travelers that stay within the region as well as open system travelers that pass into and out of the system and thereby carry information into and out of the traffic system. The mesh network module 120 works in conjunction with a transmit and receive module 122 to send and receive information, enabling the mesh network module 120 to discover other mesh enabled devices of the region and to thereby establish an ad-hoc network of traffic sensors. The mesh network module 120 may recognize incoming communications of sensor devices of the region and their geographical relationship to the current sensor device 100. Furthermore, the mesh network module 120 may provide for the transmission of information from the sensor device 100 to other sensors of the region regarding the current state of traffic without synchronously transmitting the information.

The control communications module 130 may be included to allow for direct communications with an external source of control information. A central controller or a nearby user intervention controller may submit specific control instructions for operating the traffic signaling lights. For example, a police officer may override the control scheme and otherwise take control of the traffic signaling lights at an intersection where this particular sensor device 100 is located. The control may be input to the sensor device through the communications module 130 which may work in conjunction with the transmit and receive module 122 or may have a separate dedicated communications link to the external source of instructions.

The transmit and receive module 122 may include one or more transceivers capable of communicating via wired or wireless connections. For example, each sensor device 100 within a region may be interconnected through a wired network, or each sensor device 100 may communicate with others through wireless cellular channels or via direct peer-to-peer wireless communications. The transmit and receive module 122 may work in conjunction with an external antenna 128 to provide for the wireless transmission and reception of signals.

When receiving communications from external sources, such as from other nearby sensor devices, from a central controller, and/or from a user intervention controller, the sensor device may employ an authentication module 126. The authentication module 126 checks incoming communications for proper authentication information to protect the traffic signaling system from attempts at malicious activity. Should an incoming signal be received that does not have the appropriate authentication information, then the authentication module 126 may deny the incoming information from being acted upon by the communication module 130, mesh network module 120, or any other modules of the sensor device that are able to interact with external sources of information.

The processor collects the continuously sensed current traffic state and may preserve this information for trending purposes. Both short-term and long-term trends may be determined, and the processor may adjust the common state based on the development of these trends. Accordingly, a future traffic state that may be a perturbation relative to a current common state may be the common state at that future time such that no further adaptation is needed at that time. Thus, evolving the common state over time may reduce the degree of real-time adaptation that is necessary at a given time in the future.

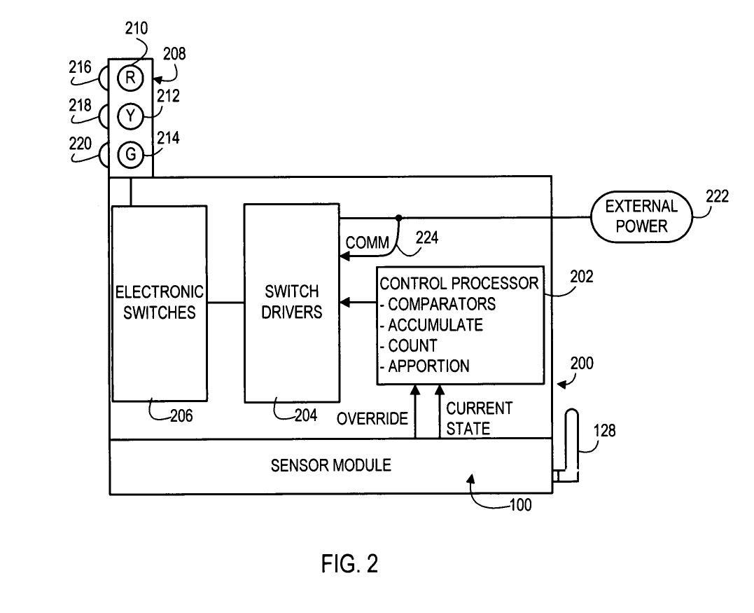

FIG. 2 shows an example of a control device 200 for controlling the traffic signaling lights 208. The control device 200 in this example includes a sensor device 100 as discussed in relation to FIG. 1 that provides the current state information for the intersection of interest as well as the current state of any nearby intersections that have provided their current state through the ad-hoc mesh network. The sensor device 100 may also provide any override command that may be received to the control device 200.

The control device 200 includes a control processor 202 that performs operations necessary to devise a control scheme to optimize traffic flow. The control processor 202 of this exemplary embodiment determines deviations of the current state of traffic from a common state and also considers the impact on the current state of traffic at the intersection of interest based on the current state of traffic at nearby intersections or locations. In doing so, the control processor 202 may utilize comparators to compare current state information to common state information, including identification of the number and type of vehicles present for each direction of travel, speed of the vehicles, and other factors as gathered by any additional sensors of the sensor device 100.

The control device 202 apportions red light and green light time to each of the directions of travel based on the current state, the expected effects on the current state due to traffic of nearby locations, and the common state upon which the common mode of operation of the traffic signaling lights 208 are operating. So, if the common mode assigns red light and green light time of a certain amount but the current state is different than the common state, then the control processor 202 determines that a change in the control scheme, i.e., a re-apportionment of red light and green light time over each of the directions of travel, is immediately necessary. The control processor 202 then determines what that change should be to find a new control scheme based on mathematical apportionment to balance the traffic flow. The control processor 202 then generates control signals that represent the new control scheme.

A set of switch drivers 204 are responsive to the control signal form the control processor 202. The switch drivers 204 turn control voltages on and off for a matrix representing each of the traffic signaling lights 208 of the intersection. The physical activation and deactivation of the traffic signaling lights 208 is performed by a set of electronic switches 206 forming the matrix that receives the control voltages from the switch drivers 204. There is an electronic switch for each traffic signaling light.

As can be seen, the traffic signaling lights 208 of this example are standard red, yellow, and green for orthogonal directions. Red light 210, yellow light 212, and green light 214 face one direction of travel while red light 216, yellow light 218, and green light 220 face the orthogonal direction. It will be appreciated that this example applies to two one-way streets intersecting at approximately right angles. However, it will be further appreciated that traffic signaling lights may also be provided in each of the opposite directions from those shown for a scenario where two two-way streets intersect. Moreover, traffic signaling lights may also be provided for streets that intersect at angles that are not approximately 90 degrees.

Power and additional communications to the control device 200 may be provided from an external power source 222. The external power source 222 may supply the power necessary to operate the control processor, switch drivers, electronic switches, and the traffic signaling lights themselves. Additionally, communication signals may be modulated onto the power line or may be provided via a separate dedicated communication line such as to provide an override communication signal 224 to the switch drivers 204. This override communication signal 224 may be provided as an alternative to providing override signals via the sensor module 100.

It will be appreciated that the sensor device and associated traffic lights can control the progression of traffic through intersections by controlling the length of the red light versus green light in the various directions of travel. However, traffic can also be re-routed through the control of the lights by relying on the traffic signals to directly convey a message to turn or not turn at an intersection or by relying on the common sense of driver's to interpret the traffic signals and make predictable decisions. For example, for a city block that has become impassable, a preceding intersection may maintain a red light while also maintaining a green left or right turn arrow. The turn arrow may be made to blink to directly convey to drivers that they should make a turn. Alternatively, the forward light may remain red while the turn light remains green perpetually so that drivers eventually become impatient and decide to turn in accordance with the green turn light. Traffic is effectively re-routed in this manner.

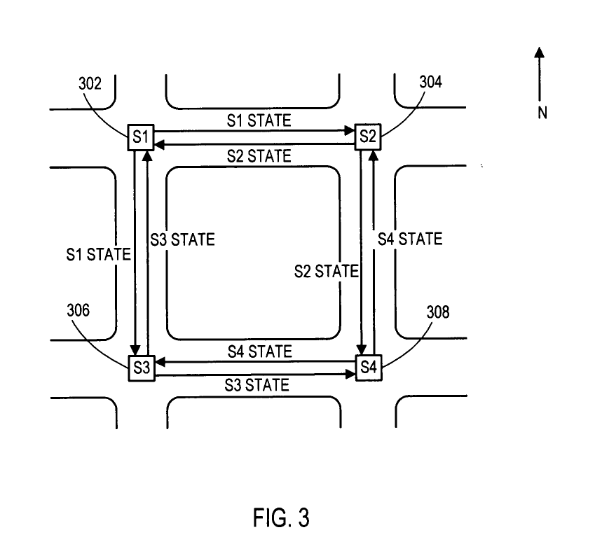

FIG. 3 shows an example of a mesh network of a city square, where each sensor device 100 of FIG. 2 of each intersection communicates with the nearby ones. The example of FIG. 3 further includes control devices 200 of FIG. 2 that are present at each intersection to provide the control scheme for the traffic signaling lights of that corresponding intersection. A first sensor-control device 302 is located at a first intersection S1. A second sensor-control device 304 is located at a second intersection S2 immediately adjacent to S1 on the east side. A third sensor-control device 306 is located at a third intersection S3 immediately adjacent to S1 on the south side. A fourth sensor-control device 308 is located at a fourth intersection S4, immediately adjacent to S2 on the south side and immediately adjacent S3 on the east side.

The sensor-control device 302 senses the current state of the corresponding intersection S1 and forwards the current state at S1 to the sensor-control device 304 at S2 and to the sensor control device 306 at S3. Likewise, the sensor-control device 304 senses the current state of the corresponding intersection S2 and forwards the current state at S2 to the sensor-control device 302 at S1 and to the sensor control device 308 at S4. The sensor-control device 306 senses the current state of the corresponding intersection S3 and forwards the current state at S3 to the sensor-control device 302 at S1 and to the sensor control device 308 at S4. The sensor-control device 308 senses the current state of the corresponding intersection S4 and forwards the current state at S4 to the sensor-control device 304 at S2 and to the sensor control device 306 at S3. Accordingly, this mesh network allows for the decentralized autonomous adaptation of the traffic signaling lights at each of the four intersections, taking into account the current state at each intersection as well as at least the current state at two adjacent intersections. Furthermore, other informational elements can be found and leveraged by using moving objects such as vehicles to carry information to other points of the system or to carry information from other points of the system into the intersections of FIG. 3. Use of such moving objects to carry information provides a stigmergic effect, similar to that observed in nature wherein information is often communicated directly through the environment.

This stigmergic effect allows for adaptation of the control schemes based on information that is obtained from distant points and that would otherwise be unavailable to the system. For example, poor weather may be approaching from the west which will eventually affect west-bound traffic. It may be desirable to provide west-bound traffic with as much green-light-time as possible to decrease the west-bound volume prior to the poor weather reaching this area. Awareness of the approaching poor weather may be introduced to the system by east-bound mesh nodes collecting the weather data and then communicating that to the traffic system of this area

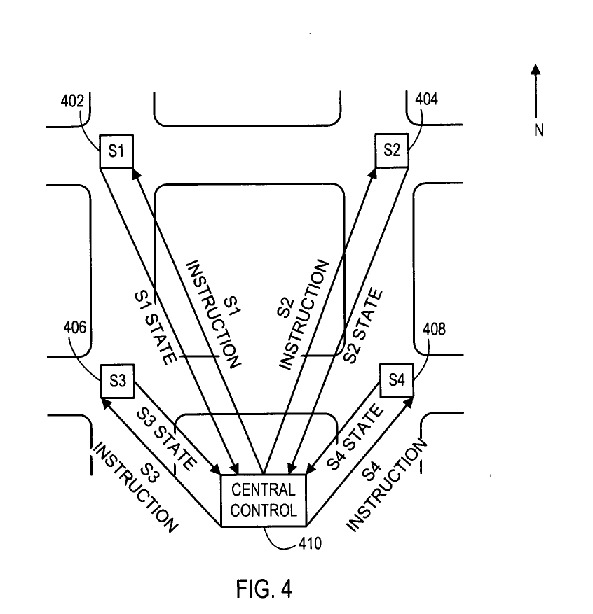

FIG. 4 shows an example of a mesh network of a city square, where each sensor device 100 of FIG. 2 of each intersection communicates with a central controller 410. The example of FIG. 4 further includes control devices 200 of FIG. 2 that are present at each intersection to provide the control scheme for the traffic signaling lights of that corresponding intersection, except that the control devices 200 may rely on the central controller 410 to provide the determination of the control scheme for each intersection such that the control devices provide that control scheme to the switch drivers. The control scheme may be communicated from the central controller 410 to each of the sensor-control devices as switching instructions to be implemented for sending control signals to the switching drivers.

A first sensor-control device 402 is located at a first intersection S1. A second sensor-control device 404 is located at a second intersection S2 immediately adjacent to S1 on the east side. A third sensor-control device 406 is located at a third intersection S3 immediately adjacent to S1 on the south side. A fourth sensor-control device 408 is located at a fourth intersection S4, immediately adjacent to S2 on the south side and immediately adjacent S3 on the east side.

The sensor-control device 402 senses the current state of the corresponding intersection S1 and forwards the current state at S1 to the central controller 410. Likewise, the sensor-control device 404 senses the current state of the corresponding intersection S2 and forwards the current state at S2 to the central controller 410. The sensor-control device 406 senses the current state of the corresponding intersection S3 and forwards the current state at S3 to the central controller 410. The sensor-control device 408 senses the current state of the corresponding intersection S4 and forwards the current state at S4 to the central controller 410. Accordingly, this mesh network allows for the centralized autonomous adaptation of the traffic signaling lights at each of the four intersections, taking into account the current state at each intersection as well as at least the current state at two adjacent intersections.

In relation to both FIGS. 3 and 4, a specific example is provided. If S1 has a common state that provides for equal apportionment of 60 seconds of green light time for east-west traffic and north-south traffic for an expected 5 cars in each direction. However, sensor-control device 302 detects that there are 2 cars and 2 buses heading north and 1 car heading west, with 1 car heading west at S2 and 4 cars heading north at S3 at a point in time. The sensor-control device 302 may then autonomously adapt the control scheme to re-apportion based on the current states so that more green light time is provided for north bound traffic and less green light time is provided for west bound traffic. In doing so, there is less of a back-up in the north bound direction than would have otherwise occurred, and the back-up in the west bound direction is minimal.

Mathematically, the sensor-control device 302 may start with the common state equal apportionment of 60 seconds each and then add to the north bound time and subtract from the west bound time. In a simple example of mathematical apportionment, the device 302 may add all north bound vehicles including those at S1 and those at S3 where a bus equates to two cars to equal 10, while adding all west bound cars including those at S1 and those at S2 to equal 2. So, there are twice as many cars in the north bound direction as expected and forty percent as many cars in the west bound direction as expected. The device 302 may then reapportion by using a formula such as providing 50% more green light time, or an extra 30 seconds, where the number is at least twice as many as expected in one direction while the number is no more than one-half as many as expected in the orthogonal direction. So, north bound traffic gets 90 seconds of green light time while west bound traffic gets 30 seconds of green light time once the 90 seconds of green light time has expired for north bound traffic. Upon the green light time expiring for west bound traffic, the control device 302 will have determined a new control scheme to apply based on the changing traffic state at S1, S2, and S3.

In allowing a control-sensor device at one intersection to communicate its current state for consideration at other intersections, the system of traffic control becomes a stigmergic routing system, where the effects created at one intersection may result in a behavioral change at another intersection that has becomes aware of the effects that have been created. So, in the above example, if the west bound traffic becomes greater due to intersections further east releasing many vehicles at once and the 90 second red light at S2 causes a back-up of traffic, this back-up is communicated to S1 so that S1 will then give additional time to the west bound traffic relative to the previous iteration of traffic cycle. As this continues over time, the system may return to the common mode as traffic flow stabilizes back to the common state, or the system may continue to adapt if unexpected numbers of vehicles continue to appear.

Furthermore, by the control devices and/or central controller maintaining a history of traffic, the common mode of traffic and the common state of traffic control may be altered to better match the realities of traffic flow. Furthermore, the results of a particular adaptation may be stored and relied upon in future control scheme adaptations based on whether the results improved traffic flow or created unintended adverse conditions. For example, the situation above may recur. If on the first occurrence, the adjustment above caused a larger than desired back-up of west bound traffic due to unforeseen west bound traffic, then next occurrence may result in a less drastic adjustment, such as an extra 20 seconds of north bound green time. If the west bound back-up occurs again, the adjustment on the next occurrence may drop to an extra 15 seconds of north bound green time. Once the back-up of north bound and west bound traffic balances over several iterations, then system may set a high probability for the adjustment that created the balance being correct for future attempts so that if multiple adjustments are available, the adjustment with the higher probability of accuracy is selected.

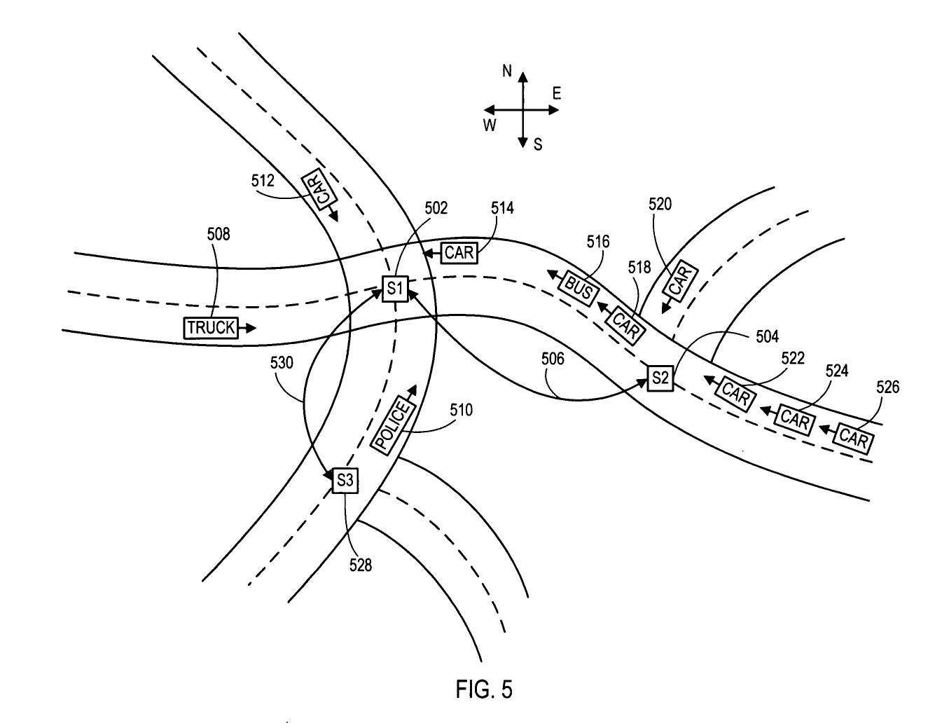

FIG. 5 shows another example of a state of traffic that involves multiple roadways, multiple directions of travel, and two intersections. Here, a first intersection S1 has a sensor-control device 502 and a second intersection S2 has a sensor-control device 504. A communication channel 506 is maintained between the sensor-control devices 502 and 504. In this example, a police car 510 is heading north after having passed through a third intersection S3 and is approaching S1, a truck is head east approaching S1, a car 512 is heading south approaching S1, and a car 514 is heading west approaching S1. The sensor-control device 502 detects these approaching vehicles as the current state.

Also in this example, three cars 522, 524, and 526 are heading west and approaching S2, a car 520 is heading south and approaching S2, while a bus 516 and a car 518 have just passed through S2 and are heading west. The sensor-control device 504 detects these approaching and passing vehicles as the current state.

The analysis module and/or control processor of the sensor-control device 502 may construct a decision state table as follows in Table 1:

TABLE 1
Intersection S1 Current State

| Traffic | Number of Vehicles in last | Number of Vehicles in last |
|---|---|---|
| Direction | 10 minutes at S1 | 10 minutes at S2 |
| North | 2 | 1 |
| South | 7 | 0 |
| East | 3 | 1 |
| West | 24 | 34 |

The sensor-control device 502 may employ a common state that sets forth a maximum green light time of zero when no cars are waiting and a minimum green light time of 45 seconds when at least one car is waiting (where the common expectation is that at least one other car will approach within the 45 seconds), and a maximum green light time of 4 minutes when a maximum threshold is reached, e.g., 25 cars waiting. These times are then modulated by the influx of vehicles that are known to be coming based on the current state as communicated by S2. For example, if only a single car comes through and no more are expected within a period of time greater than the minimum on time, then the green light can be switched to a red light once 10 seconds have passed rather than remaining on for the full 45 seconds. If an unusually high number of vehicles are approaching based on the current state sensed at S1 as well as the current state sensed at S2, then the green light for west bound traffic may be left on for as long as possible, such as until another vehicle approaches from the north or sound and waits a maximum allowable amount of time, e.g., 4 minutes.

The specific scenario shown involves heavy traffic 518, 522, 524, 526 heading West through light S2, including a bus 516. Light S2 is intermittently optimizing cars such as car 520 from the side road by allowing more on time to the main road. The light S2 is communicating to the next light S1 via link 506 (mesh or otherwise), that high volumes of traffic are coming from the East in a likely timeframe of X minutes. Light S2 is also communicating to the light S1 that a long, time consuming object (a bus) is on its way so light S1 can apportion timings accordingly. Lights S1 and S2 begin collaborating on the dynamic apportionment of time per light, inclusively, taking into account both nodes S1 and S2. Light S1 is in the process of increasing East-to-West on time for the coming traffic when a police car 510 approaches, coming through light S3 from the South. Light S3 has determined through use of the comparative analysis engine that it is a police car, and sends a message to the next light in the direction of police car travel, or S1, that a police car is coming. Light S1 then limits the East-to-West on time to allow the police car to pass as soon as possible, even though other conditions say traffic will be slowed back to light S2.

This scenario always gives high priority vehicles such as police cars and other emergency vehicles priority based on detecting them via the comparative analysis. Alternatively, there is a comparative analysis to determine if the police had a siren on or a flashing blue light, or both. If so, then the system of traffic lights determines that there is an emergency that triggers a change to other traffic optimization control schemes already underway. Additionally, the police car may generate a communication that identifies the police car and/or that specifies whether there is an emergency situation at hand that requires the police car to be given priority over other traffic optimization schemes.

In the example of FIG. 5, car 520 which is an autonomous traffic object may carry with it information from a neighboring traffic system that is not part of the current domain or mesh network. Upon approaching light S2, this information may then be communicated to S2, where it can then be factored into the traffic analysis scheme by S2 and then communicated to a central controller, if any, or to surrounding lights S1, S3, etc. For example, car 520 may carry with it information that a large number of vehicles are approaching S2 from the direction car 520 is traveling. S2 may then indicate to S1 that S2 must stay green to ensure that cars 522, 524, and 526 pass through because light S2 will need to soon stop west-bound traffic in order to deal with the large number of vehicles approaching behind car 520. Lights S1 and S3 may then also optimize to account for the increased west-bound green light of S2 which will be followed by an increased west-bound red light of S2. Had car 520 not provided this information from the neighboring traffic system with the traffic system of FIG. 5, then the lights S1-S3 would have to deal with the encroaching traffic only upon that traffic coming into sensing range of the traffic system. This last minute approach might cause more traffic delay than if the traffic system prepares for the oncoming traffic based on the out-of-network data provided by car 520.

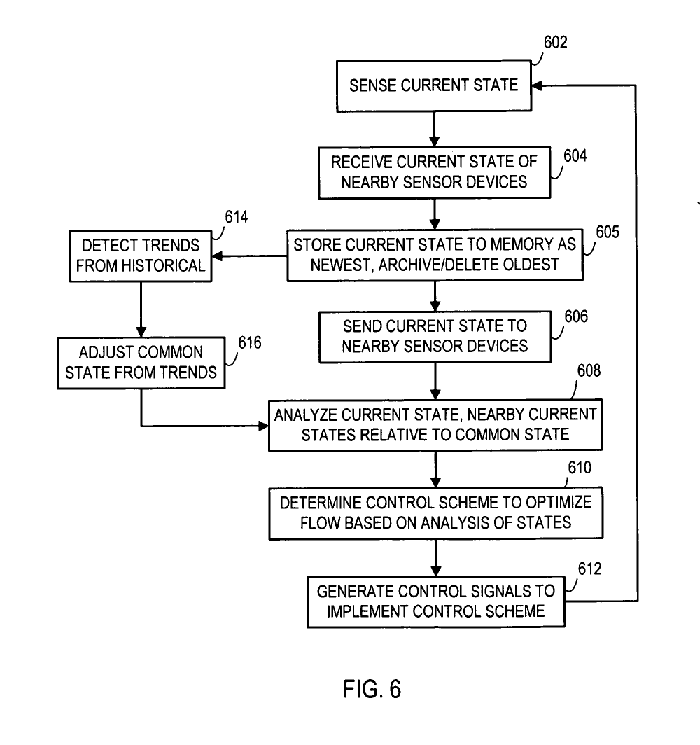

FIG. 6 shows an operational flow that summarizes what may be performed within the autonomous mesh network of sensor-control devices according to an exemplary embodiment. Initially, a sensor-control device senses the current state for the intersection of interest at sensing operation 602. The sensor-control device then receives the current state for the nearby locations and intersections at reception operation 604. As discussed above in relation to FIGS. 3 and 4, this may be received directly from the sensor-control devices at the nearby locations, or may be provided by a central controller in communication with each of the sensor-control devices of the region. At this point, the current state may be stored to memory as the newest memory operation 605 and can be considered when making current changes to the traffic control scheme as well as preserved as historical data for subsequent use when making future changes to the control scheme and when determining patterns or trends. Because memory space is not infinite, the memory may eventually be filled to capacity with state information such that the oldest may be archived or otherwise deleted from memory to make room for storage of the newest current state information.

Upon storing the current state information, one path of the logical operations may provide for updating the common state based on the historical current state information that has been maintained. The historical current state information may be analyzed for patterns or trends at detection operation 614. Here deviations from the common state that have persisted can be detected to reveal new patterns and trends of traffic that have become the norm rather than a perturbation. Accordingly, once a deviation has become the norm, due to its recurrence on a regular basis over a satisfactory period of time (e.g., 1 month) the common state can then be adjusted for the trend at adjustment operation 616. Here, the common state is adapted to reflect that the trend or pattern is now a part of the common state as opposed to being a deviation from it. Therefore, as the trend recurs, the common state already accounts for that trend such that a real-time adjust of the traffic control scheme is not needed.

Returning to the primary path of the logical operations, the sensor-control device additionally sends the current state to nearby sensors at send operation 606. This may be done either directly in a peer-to-peer fashion or by sending it to a central controller than then may distribute it to each sensor-control device for which it is relevant.

Upon the sensor-control devices having obtained the current state and the nearby current states, the analysis may occur to determine the number and type of vehicles that are relevant to the current execution of the traffic signaling lights at analysis operation 608. Here the common state may be considered to determine whether a deviation is occurring and whether an adaptation is needed for the control scheme. As noted above, the common state may be adapted over time to account for patterns and trends that recur such that deviations from the common state are more likely to actually be deviations from the current traffic norms. Once it is determined that a deviation from the common state requiring an adaptation is required, a determination is made as to how the control scheme must be changed to optimize the traffic flow at control operation 610. As discussed in relation to FIG. 4, the analysis operation 608 and the control operation 610 may occur for one or more intersections of the network at a central controller rather than at each sensor-control device. After the new control scheme to be applied is determined, the sensor-control devices then generate control signals that control the traffic signaling lights to thereby implement the control scheme at signal operation 612. Operational flow then returns to sense operation 602 where the current state is then sensed based on the effects that the new control scheme causes.

It will be noted from the discussion above that historical traffic data is preserved for some length of time. This historical traffic data may be analyzed, such as at the central control 410 of FIG. 4 or at any of the autonomous nodes 100 that also store historical data, in order to determine the trends and patterns. Thus, the evolution of the common state may occur at the central control 410 and/or at each autonomous control node such as those of FIG. 3.

The analysis of this historical data allows the central control 410 and/or each autonomous node to perform syndromic surveillance. Syndormic surveillance is commonly used in the detection and control of disease outbreaks, see http://www.syndromic.org. In the context of the present exemplary embodiments, syndromic surveillance may be similarly used to detect a negative traffic condition or trend, analogous to a disease, and then to attempt a recreation of the spreading of that negative trend to find its origin. In doing so, traffic planning decisions, real-time traffic control, and so on may be designed to alleviate existing syndromes and to prevent a recurrence of the syndrome at the same location as well as at other locations.

While the invention has been particularly shown and described with reference to various exemplary embodiments thereof, it will be understood by those skilled in the art that various other changes in the form and details may be made therein without departing from the spirit and scope of the invention.

What is claimed is:

1. A device for controlling traffic, comprising:
at least one sensor that produces at least one sensor signal representative of a current traffic state; and
an analysis module that analyzes the sensor signal to determine the current traffic state, to compare the current traffic state to a common traffic state, to determine deviations of the current traffic state from the common traffic state, to determine a control scheme based on the deviations, wherein the control scheme controls the activation of traffic signaling lights to optimize traffic flow, and to produce the control signals representative of the control scheme.

2. The device of claim 1, wherein the analysis module communicates the control signals to switches for activating traffic signaling lights according to the control signals.

3. The device of claim 1, further comprising a communications module that receives messages, wherein the messages received include data specifying a current traffic state occurring at a location other than the location of the sensor and wherein the analysis module determines the control scheme by analyzing the current traffic state as specified by the data received through the communications module in addition to the current traffic state represented by the sensor signal.

4. The device of claim 3, wherein the communications module sends messages, wherein the messages sent by the communication module include data specifying the current traffic state as determined by the analysis module.

5. The device of claim 1, wherein the at least one sensor includes a camera and wherein the at least one sensor signal represents a number of vehicles being sensed per unit of time.

6. The device of claim 5, wherein the at least one sensor signal further represents a speed of vehicles being sensed.

7. The device of claim 1, further comprising a weather sensor that produces a sensor signal representative of the current state of the weather.

8. The device of claim 1, wherein the control scheme includes an amount of time for a traffic light to be red and an amount of time for the traffic light to be green.

9. A method of controlling traffic of an intersection or other advantageous location, comprising:
sensing a current state of traffic at a current location;
comparing the current state of traffic for the current location to a common state of traffic for the current location to find deviations from the common state and to determine a control scheme to optimize traffic flow based on the deviations; and
producing control signals representative of the control scheme to control the activation of traffic signaling lights so as to optimize traffic flow.

10. The method of claim 9, further comprising:
sending messages to a central controller for analysis of the current traffic state relative to the common state and relative to a current state of traffic at nearby locations; and
receiving instructions from the central controller.

11. The method of claim 10, wherein receiving messages comprises receiving messages from traveling nodes.

12. The method of claim 9, further comprising communicating the control signals to control switches so as to activate traffic signaling lights to optimize traffic flow.

13. The method of claim 9, further comprising storing each detected current state, analyzing the stored current states, and altering the common state based on the analysis.

14. The method of claim 9, wherein sensing comprises utilizing at least one of a camera, a sound pressure sensor, and a smoke detector.

15. A computer readable medium containing instructions for performing acts to control traffic, the acts comprising:
sensing a current state of traffic;
comparing the current state of traffic to a common state of traffic to find deviations from the common state and to determine a control scheme to optimize traffic flow based on the deviations; and
producing control signals representative of the control scheme to control the activation of traffic signaling lights to optimize traffic flow.

16. The computer readable medium of claim 15, the acts further comprising comparing the current state of traffic at one location to a current state of traffic at a nearby location when determining the control scheme.

17. The computer readable medium of claim 16, wherein the current state of traffic at the nearby location is provided from a sensor of a nearby vehicle.

18. The computer readable medium of claim 15, wherein sensing the current state of traffic comprises detecting whether high priority vehicles that are not of the common state are present.

19. The computer readable medium of claim 15, wherein sensing the current state of traffic comprises detecting whether a volume of vehicles that are present is different than a range of volume of vehicles of the common state and detecting whether a vehicle of a first type is present where vehicles of the first type are not present in the common state.

20. The computer readable medium of claim 15, wherein the common state is based on the location, day of the week, and a time of day and wherein the acts further comprise adapting the common state by finding trends from historical current states.
